(19) United States
(12) Patent Application Publication
(10) Pub. No.: US 2015/0154160 A1
(43) Pub. Date: Jun. 4, 2015

(54) SYSTEM AND METHOD FOR DISPLAYING IMAGE ON WEBPAGE ACCORDING TO VISIBLE AREA

(71) Applicants: Inventec (Pudong) Technology Corporation, Shanghai (CN); Inventec Corporation, Taipei (TW)

(72) Inventor: LONG CHEN, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/246,964

(22) Filed: Apr. 7, 2014

(30) Foreign Application Priority Data
Nov. 29, 2013 (CN) 201310627922.0

(51) Int. Cl. G06F 17/22; G06F 17/30

(52) U.S. Cl. CPC G06F 17/2247; G06F 17/30247

(57) ABSTRACT

A system and method for displaying an image on a webpage according to a visible area are disclosed, in which the property of the image object on the target webpage is amended, so that the image object presents the alternative image having a size identical to that of the alternative object used for representing the target image on the browser on the target webpage, and then when the target image is completely loaded in and the alternative image corresponding to the target image is located within the visible area or below the visible area, restores the amended property of the image object corresponding to the target image completely loaded in, so that the target image is presented on the target webpage in replace of the alternative image, whereby achieving in the result of avoiding an adverse effect on browsing the webpage content by the user.

### BACKGROUND OF THE RELATED ART

1. Technical Field

The present invention relates to a webpage image displaying system and method, and particularly to a webpage image displaying system and method according to a visible area on a webpage.

2. Related Art

In a browser, load-in of syntaxes and images of the HyperText Markup Language (HTML) are executed asynchronously. When the browser loads in the HTML syntax, if the loaded-in HTML syntaxes comprise a tag used for displaying images, the browser may use an alternative image representing the image on the webpage previously, and then the image is officially loaded in. Only after the image is completely loaded in, the image may be used and displayed in replace of the image on the webpage.

In some webpages, developers of the webpage might not write down a width and height of a displayed image on a tag used for displaying the image. If the image has a size larger than that of the alternative image, a lower portion of content on the webpage will be forced to shift downwards when the browser finishes the loading-in of the image and displayed on the webpage.

In the case that a user has rolled on the webpage to below the image frame having not displayed before the image is loaded in by the browser. Since the webpage content below the image will shift downwards, resulting in that the webpage content under being browsed by the user may shift downwards. If the user desires to continue to browse the webpage content browsed previously, he/she needs to roll the webpage to the previously browsed webpage content for the subsequent browsing process.

Once multiple images are included above the webpage content browsed by the user, the webpage content shifts downwards may continuously occur after each image is loaded in, until all the images above the browsed webpage content by the user are loaded in and displayed on the webpage. This apparently a troublesome job for the user browsing through the webpages.

In view of the above, it may be known that there has long been an issue where webpage content below the image may shift downwards when the image is displayed on the webpage. Thus, it is quite a need to set forth a technical means for improvement regarding this issue encountered in the prior art.

### SUMMARY

In view of the issue encountered in the prior art where a webpage content below the image may shift downwards when the image is displayed on the webpage, the present invention discloses a system and method for displaying an image on a webpage according to a visible area.

According to the present invention, the system for displaying an image on a webpage according to a visible area, applied onto a browser when displaying a target webpage, comprises an object searching module, searching all image objects in the target webpage through a document object model (DOM) of the target webpage; an property amending module, amending at least one property of each of the image objects, so that each of the image objects presents an alternative image having a size identical to a size of an alternative object used for representing the target images by the browser on the target webpage; and a related position determining module, determining a related position with respect to a visible area on the target webpage and the alternative image presented by the image object, when a target image corresponding to one of the image object is finished being loaded-in, and restoring the property of the image object corresponding to the loaded target image, so that the loaded target image presents on the target webpage in replace of the alternative image presented by the image object when the alternative image is located within the visible area or below the visible area.

According to the present invention, the method for displaying an image on a webpage according to a visible area, applied onto a browser when displaying a target webpage, comprises steps of searching all image objects in the target webpage through a document object model (DOM) of the target webpage; amending at least one property of each of the image objects, so that each of the image objects presents an alternative image having a size identical to a size of an alternative object used for representing the target images by the browser on the target webpage; determining a related position with respect to a visible area on the target webpage and the alternative image presented by the image object, when a target image corresponding to one of the image object is completed loaded-in; and restoring the property of the image object corresponding to the loaded target image, so that the loaded target image presents on the target webpage in replace of the alternative image presented by the image object when the alternative image is located within the visible area or below the visible area.

The system and method of the present invention has the difference as compared to the prior art that the present invention amends the property of the image object in the target webpage, so that the image object presents the alternative image having a size identical to that of the alternative object used for representing the target image by the browser on the target webpage, and then when the target image is completely loaded in and the alternative image corresponding to the target image is located within the visible area or below the visible area, restores the amended property of the image object corresponding to the target image completely loaded in, so that the target image is presented on the target webpage in replace of the alternative image, whereby solving the issue encountered in the prior art, and achieving in the result of avoiding an adverse effect on browsing the webpage content by the user.

### BRIEF DESCRIPTION OF THE DRAWINGS

The invention will become more fully understood from the detailed description given herein below illustration only, and thus is not limitative of the present invention, and wherein:

FIG. 1 is a systematic diagram illustrating a system for displaying an image on webpage according to a visible area according to the present invention;

FIG. 2 is a flowchart of a method for displaying an image on a webpage according to a visible area; and

FIG. 3A and FIG. 3B are a schematic diagram a flowchart of a method for displaying an image on a webpage according to a visible area according to an embodiment of the present invention.

### DETAILED DESCRIPTION

The present invention will be apparent from the following detailed description, which proceeds with reference to the accompanying drawings, wherein the same references relate to the same elements.

In the present invention, when a webpage content of a target webpage is displayed on a browser, an alternative image is presented on the target webpage in replace of a target image corresponding thereto. Further, a related position with respect to a visible area on the target webpage and the alternative image on the target webpage is used to determine if the alternative image is restored into the target image corresponding thereto for presenting the target image on the target webpage. Generally, the present invention is included in a script which may be imbedded in the target webpage. However, this is merely an example, without limiting the present invention.

In the present invention, the alternative image is used to replace temporally the target image corresponding thereto to present on the target webpage, where the alternative image has a position identical to that of the target image on the target webpage, and the alternative image presented by the browser has a size identical to that of the target image on the target webpage. The alternative image used on the browser is used before the target image is loaded in by the browser, and used as an object, such as an icon, representing the target image still having not been loaded onto the target webpage.

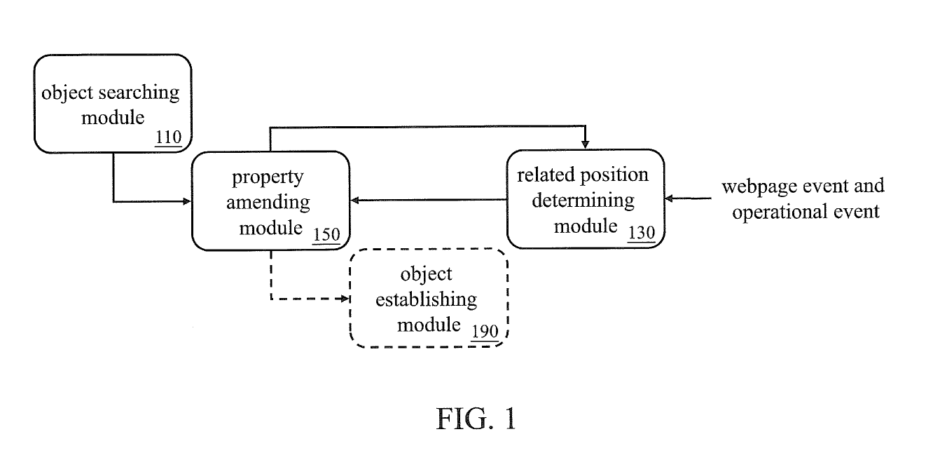

The operation of the present invention will be described with reference to FIG. 1, in which a systematic diagram illustrating a system for displaying an image on webpage according to a visible area according to the present invention is shown. As shown in FIG. 1, the present invention comprises an object searching module 110, a related position determining module 130 and a property amending module 150.

The object searching module 110 is used to search all image objects in a target webpage. Generally, the object searching module 110 may acquire all the objects in the target webpage through a document object model (DOM), and determines if the acquired object is an image object according to the property acquired.

In a target webpage, each image object may correspond to an image. In this invention, the image corresponded by the image object is termed as a “target image”, which may be displayed in the webpage content of the target webpage on the browser.

The related position determining module 130 is used to determine a related position with respect to an alternative image corresponded by the target image as completely loaded in and a visible area of the target webpage. The related position determining module 130 may determine, when the browser has finished loading in the target image, that the target image has been completely loaded in through an onComplete event generated by the image object when the target image is finished being loaded in. However, this manner of determination regarding how the target image is completely loaded in is not only limited to this example in this invention.

The related position determining module 130 also determines a related position with respect to the target image as completely loaded in and the visible area of the target webpage when the webpage content of the target webpage displayed on the visible area has a change occurring. The related position determining module 130 may monitor operational events of the browser, and the monitored operational event may change the webpage content of the target webpage displayed on the visible area, such as a frame roll event, and a frame zoom-out event. However, the manner that the related position determining module 130 determines the change of the visible area of the target webpage is not only limited as this example.

For example, the related position determining module 130 may also continuously acquire visible position information of the visible area of the target webpage, and compare the visible position information with the same acquired last time. When the comparison shows as being different, the webpage content of the target webpage displayed on the visible area is indicated as having a change. The visible position information acquired by the related position module 130 may represent the position of the visible area on the target webpage, such as a coordination point on the target webpage. However, the visible position information of the present invention is not only limited as this example.

The related position determining module 130 may acquire an image position information of the alternative image corresponded by the target image on the target webpage. Since the image position information of the alternative image on the target webpage is the same as the image position information of the target image, the related position determining module 130 may acquire the image position information according to the property of the image object corresponded by the target image. The image position information acquired by the related position determining module 130 may present the position of the alternative image presented by the image object on the target webpage, such as a coordination point on the target webpage. However, the image position information mentioned in the present invention is not only limited as this example.

At the same time, the related position determining module 130 may also acquire the visible position information of the visible area of the target webpage according to the property of the window object in the target webpage, and determine if the alternative image corresponded by the target image having been loaded in completely is located within the visible area or above or below the visible area, according to the image position information and the visible position information.

The property amending module 150 amends one or more properties of the image object searched by the object searching module 110, so that the size of the alternative image presented by the amended image object on the target webpage as identical to that of the alternative object used by the browser, and the alternative object represents the target image having not been loaded in completely on the target webpage. In some embodiments, the property amending module 150 may first determine if the property, an image length, of the image object, is set, and then amend the property of the image object only when the property, the image length, of the image object is not set.

The property amending module 150 may amend an image source address of the image object into a download address of the alternative image, so that the image presented on the target webpage by the browser according to the image object is the alternative image but is not the target image, in which the size of the alternative image is identical to the size of a temporary image presented on the target webpage by the alternative object used by the browser. The property amending module 150 may also amend the property of the image length and an image width of the image object into the same as that of the alternative object used by the browser.

The property amending module 150 also restores the property of the image object corresponded by the target image having been completely loaded in when the related position determining module 130 has determined the alternative image corresponded by the target image as loaded in completely as being located within the visible area or below the visible area, i.e. not above the visible area. For example, the property amending module 150 restores the property of the image source address of the image object corresponded by the target image having been completely loaded in from the download address of the alternative image into the download address of the target image if the property amending module 150 has amended previously the data stored in the property of the image source address of the image object corresponded by the target image into the download address of the alternative image. As such, the target image is replaced by the alternative image, and thus completely presented on the target webpage by the browser. If the property amending module 150 has amended the property of the image height and width of the image object, the property amending module 150 restores the data of the property of the image height and width of the image object.

In addition, the present invention may also include an additional object establishing module 190. When the property amending module 150 has amended the data in the property of image source address of the image object (download address of the target image) into the download address of the alternative image, the object establishing module 190 may add a temporal object in the target webpage, in which the property of the image source address of the temporal object is the image source address of the image object before amended, so that the browser may download the target image according to the download address of the target image.

The object establishing module 190 may also delete the temporal object as established in the target webpage previously when the property amending module 150 has amended the property of the image source address of the image object from the download address of the alternative image into the download address of the original target image.

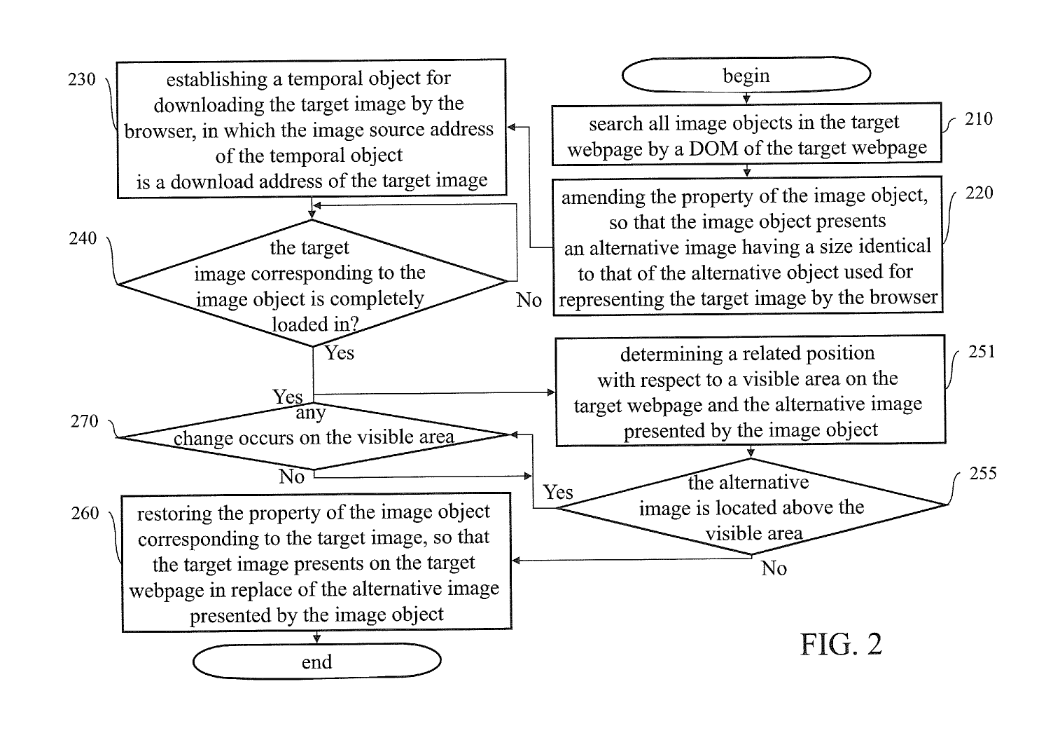

Next, an embodiment is set forth to explain how the system and method of the present invention operate. FIG. 2 is a flowchart of a method for displaying an image on a webpage according to a visible area. In this embodiment, assume that the target webpage does not include the present invention, instead the browser itself or a plug-in of the browser embeds the script including the present invention into the target webpage. However, the present invention is not only limited to this example. A developer of the target webpage may also draft the script including the present invention into the target webpage when developing the target webpage.

When the user uses the browser to browse the target webpage, the browser may download the target webpage, and the object searching module 110 may search all image objects in the target webpage in the course of downloading the target webpage (S210). In this embodiment, assume the object searching module 110 may search all the image objects in the target webpage through the document object model (DOM), which has to be initialized by the browser after the browser finishes downloading the target webpage.

After the object searching module 110 searches out all the image objects in the target webpage (S210), the property amending module 150 may amend the property of the image object searched out by the object searching module 110, so that the image object may present an alternative image having a size identical to that of the alternative object used to represent the target image by the browser (S220). In this embodiment, assume the property amending module 150 may amend the property of the image source address of the image object from the download address of the target image to the download address of the alternative image.

If the original target webpage has not downloaded all images of the target webpage, the script embedded into the target webpage mentioned in this embodiment has to include the object establishing module 190. After the property amending module 150 amends the property of the image object, the object establishing module 190 may establish a temporal object having the property of the image source address as the download address of the target image in the target webpage, so that the browser may download the target image (S230).

If the target webpage has originally downloaded all images of the target webpage in advance, or after the object establishing module 190 has established the temporal object in the target webpage, the related position determining module 130 may determine each of the target image corresponded by the image object in the target webpage has been completely loaded in (S240). In this embodiment, assume the related position determining module 130 may determine if the downloaded target image has generated an “onComplete” event in the webpage. When the “onComplete” event representing that the target image has been completely loaded in is generated, the related position determining module 130 may determine that one of the target images have been loaded in.

If there is no event generated regarding that the target image finishes loading in the webpage, the related position determining module 130 may continuously wait for such event to be generated. If this webpage event has been generated, the related position determining module 130 may determine a related position with respect to the alternative image corresponded by the target image as having been completely loaded in and the visible area of the target webpage on the target webpage (S251).

In this embodiment, the related position determining module 130 may acquire an image distance between the alternative image and a top end of the target webpage (an image position information) by referring to the “offsetTop” property of the image object presented the alternative image on the target webpage, and may also acquire a area distance between the visible area of the target webpage and the top end of the target webpage (visible position information) by referring to the “pageYOffset” property of the window object of the target webpage, and determine if the target image as having been completely loaded in is located within the visible area of the object webpage or above or below the visible area of the target webpage according to the image distance and the area distance.

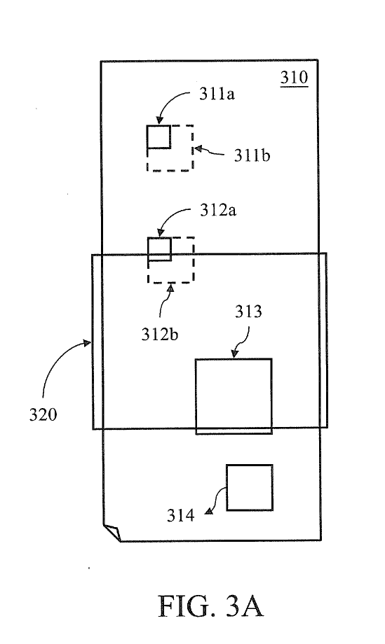

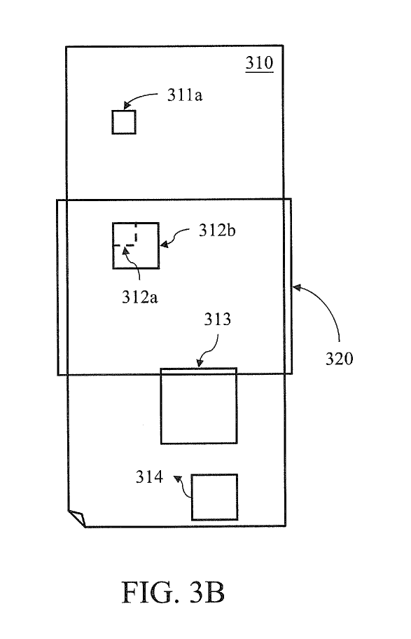

After the related position determining module 130 determines the related position with respect to the alternative image corresponded by the target image having been completely loaded in and the visible area of the target webpage on the target webpage (S251), the related position determining module 130 may further determine if the target image loaded in is located above the visible area (S255). If no, i.e. the loaded target image corresponding to the alternative image is located within or below the visible area, the property amending module 150 may restore the property of the image source address of the image object presenting the alternative image from the download address of the alternative image into the download address of the target image, so that the target image is displayed on the target webpage by the browser in replace of the alternative image (S260). As shown in FIG. 3A, where the target image 313 and the target image 314 are shown, the target image 313 is located within the visible area 320, and the target image 314 below the visible area 320.

If the target image having been completely loaded in is located above the visible area, the property amending module 150 will not restore the property of the image source address of the image object presenting the alternative image into the download address of the target image, as shown as the alternative image 311a and the alternative image 312a in FIG. 3A.

At the same time, the related position determining module 130 may further determine if there is a change occurring on the visible area of the target webpage (S270). In this embodiment, assume the related position determining module 130 may monitor operational events of the browser, and determine a change of the visible area of the target webpage has occurred when a frame roll event is monitored.

If the related position determining module 130 determines the webpage content of the target webpage displayed on the visible area of the target webpage is no change, the related position determining module 130 may also continuously wait for a change to occur on the visible area of the target webpage. If the related position determining module 130 determines a change does occur on the visible area of the target webpage, as shown in FIG. 3B, the target webpage 310 is rolled upwards and the visible area of the target webpage may shift upwards correspondingly. At this time, the related position determining module 130 may determine the related position with respect to the alternative image corresponded by the target image having been completely loaded in and the visible area of the target webpage on the target webpage (S251), so as to determine if the alternative image corresponded by the target image having been completely loaded in is located above the visible area (S255).

If no, the property amending module 150 may restore the property of the image source address of the image object presenting the alternative image into the download address of the target image, so that the target image is displayed on the target webpage by the browser in replace of the alternative image (S260), such as the target image 312b replacing the alternative image 312a. If the alternative image corresponded by the target image having been completely loaded in remains located above the visible area, the related position determining module 130 may continuously determine if there is a change occurring on the visible area displaying the webpage content of the target webpage (S270). The property amending module 150 will still not restore the image source address of the image object presenting the alternative image into the download position of the target image, as shown as the alternative image 311a.

In view of the above, it may be known that the present invention has the difference as compared to the prior art that the present invention amends the property of the image object in the target webpage, so that the image object presents the alternative image having a size identical to that of the alternative object used for representing the target image by the browser on the target webpage, and then when the target image is completely loaded in and the alternative image corresponding to the target image is located within the visible area or below the visible area, restores the amended property of the image object corresponding to the target image completely loaded in, so that the target image is presented on the target webpage in replace of the alternative image, whereby solving the issue encountered in the prior art where a webpage content used by the user below the image may shift downwards when the image is displayed on the webpage, and achieving in the result of avoiding an adverse effect on browsing the webpage content by the user.

Furthermore, the computer system and clicking signal processing method therefore according to the present invention may be implemented in hardware, software or a combination thereof. Alternatively, the method may also be implemented in a single unit or separate computer systems connected with one another with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for displaying an image on a webpage according to a visible area, applied onto a browser when displaying a target webpage, comprising steps of:
searching all image objects in the target webpage through a document object model (DOM) of the target webpage;
amending at least one property of each of the image objects, so that each of the image objects present an alternative image having a size identical to a size of an alternative object used for representing the target images by the browser on the target webpage;
determining a related position with respect to a visible area on the target webpage and the alternative image presented by the image object, when a target image corresponding to one of the image object is completed loaded-in; and
restoring the property of the image object corresponding to the loaded target image, so that the loaded target image presents on the target webpage in replace of the alternative image presented by the image object when the alternative image is located within the visible area or below the visible area.

2. The method as claimed in claim 1, further comprising a step of determining a related position with respect to the alternative image presented by the image object and the visible area on the target webpage again when a webpage content displayed on the visible area changes, and restoring the property of the image object corresponding to the loaded target image so that the loaded target image presents on the target webpage in replace of the alternative image presented by the image object when the alternative image is located within the visible area or below the visible area.

3. The method as claimed in claim 1, wherein the step of determining a related position of the visible area on the target webpage and the alternative image presented by the image object further comprises a step of acquiring an image position information of the alternative image within the target webpage and a visible position information of the visible area within the target webpage, and determining the related position with respect to the alternative image and the visible area according to the image position information and the visible position information.

4. The method as claimed in claim 1, wherein the step of amending the property of the image object further comprises a step of amending an image length and an image width of the image object.

5. The method as claimed in claim 1, wherein the step of amending the property of the image object further comprises a step of amending an image source address of the image object.

6. The method as claimed in claim 5, wherein the step of amending the image source address of the image object further comprises a step of establishing a temporal object for downloading the target image, in which the image source address of the temporal object is a download address of the target image.

7. A system for displaying an image on a webpage according to a visible area, applied onto a browser when displaying a target webpage, comprising:
an object searching module, searching all image objects in the target webpage through a document object model (DOM) of the target webpage;
a property amending module, amending at least one property of each of the image objects, so that each of the image objects presents an alternative image having a size identical to a size of an alternative object used for representing the target images by the browser on the target webpage; and
a related position determining module, determining a related position with respect to a visible area on the target webpage and the alternative image presented by the image object, when a target image corresponding to one of the image object is completed loaded-in, and restoring the property of the image object corresponding to the loaded target image, so that the loaded target image presents on the target webpage in replace of the alternative image presented by the image object when the alternative image is located within the visible area or below the visible area.

8. The system as claimed in claim 7, wherein the related position determining module further determines a related position with respect to the alternative image presented by the image object and the visible area on the target webpage again when a webpage content displayed on the visible area changes.

9. The system as claimed in claim 7, wherein the related position determining module acquires an image position information of the alternative image within the target webpage and a visible position information of the visible area within the target webpage, and determines the related position with respect to the alternative image and the visible area according to the image position information and the visible position information.

10. The system as claimed in claim 7, wherein the properties of each of the image object are an image length and an image width of the image object.

11. The system as claimed in claim 7, wherein the property of each of the image object is an image source address of the image object.

12. The system as claimed in claim 11, further comprising an object establishing module, establishing a temporal object for downloading the target image, in which the image source address of the temporal object is a download address of the target image.
